(19) United States
(12) Patent Application Publication
(10) Pub. No.: US 2022/0138917 A1
(43) Pub. Date: May 5, 2022

(54) Apparatus, System And Methods For Air-Water Interface Imaging Distortion Correction

(71) Applicants: Shiwei Liu, Lehi, UT (US); Lishao Wang, Halifax (CA); Xiaoge Cheng, Beijing (CN); Fred Lu, Halifax (CA)

(72) Inventors: Shiwei Liu, Lehi, UT (US); Lishao Wang, Halifax (CA); Xiaoge Cheng, Beijing (CN); Fred Lu, Halifax (CA)

(21) Appl. No.: 17/513,969

(22) Filed: Oct. 29, 2021

Related U.S. Application Data
(60) Provisional application No. 63/106,915, filed on Oct. 29, 2020.

(51) Int. Cl. G06T 5/00; G06T 5/50; G06V 10/82

(52) U.S. Cl. CPC G06T 5/006; G06T 5/50; G06T 2207/20081; G06T 2207/10028; G06T 2207/20084; G06V 10/82

(57) ABSTRACT

The present invention, in some embodiments thereof, relates to apparatus, system and methods for image distortion correction when scanning/imaging an air-water interface (AWI), or any such interfaces between two media including air and glass, among others. According to one embodiment, the apparatus comprises of a means of scanning a mean water level, and twos canners, wherein is set slightly above the water surface, and one positioned just below, with the scanners having an intersecting view of the AWI. A suitably trained machine learning algorithm recognizes key features from both the above-water and underwater scans, determines distortion from the AWI, make a correction of the distortion and automatically stitch the distortion-corrected scans together. According to another embodiment, the resulting single complete, accurate, and high-density point cloud of all surface profiles in, around, and below the AWI area.

### FIELD OF INVENTION

In general, the current invention relates to apparatus, system and methods for image distortion correction, and specifically adapted for improved scanning/imaging an object profile in an air-water interface (AWI) zone, or any such interfaces between two media of different refractive indices including air and glass, oil and water, among others.

### BACKGROUND OF THE INVENTION

Current technologies for both above-water and underwater scanning have developed to the level where high-density point cloud scans can reach accuracies much finer than the required 1.0 mm. Commercially available above-water laser scanners can reach accuracies of 0.025 mm, while underwater counterparts can reach 0.1 mm. However, through-water scanning remains difficult even at extremely shallow water depths no matter the type of scanner used, which makes creating accurate, high-density point clouds of the Air-Water Interface (AWI) area difficult in even the most optimal conditions.

The challenge of through-water scanning is a physics problem: reflection and refraction. When electromagnetic radiation crosses a smooth interface into a dielectric medium that has a higher refractive index (nt>ni), two phenomenon can occur, that is reflection and refraction. The angle of reflection, Or, equals the angle of incidence, θi, where each is defined with respect to the surface normal. The angle of refraction, θt, (t for transmitted) is described by Snell's law (of Refraction): nᵢ sin θᵢ=nₜ sin θₜ.

It is a known phenomenon that when light traveling one transparent medium encounters a boundary with a second transparent medium (e.g., air and glass), a portion of the light is reflected and a portion is transmitted into the second medium. As the transmitted light moves into the second medium, it changes its direction of travel; that is, it is refracted. The law of refraction, Snell's law above, describes the relationship between the angle of incidence (θ₁) and the angle of refraction (θ₂), measured with respect to the normal (“perpendicular line”) to the surface; in mathematical terms: N₁ sin θ₁=n₂ sin θ₂, where n₁ and n₂ are the index of refraction of the first and second media, respectively. The index of refraction for any medium is a dimensionless constant equal to the ratio of the speed of light in a vacuum to its speed in that medium.

The amount of bending of a light ray as it crosses a boundary between two media is dictated by the difference in the two indices of refraction. When light passes into a denser medium, the ray is bent toward the normal. Conversely, light emerging obliquely from a denser medium is bent away from the normal. In the special case where the incident beam is perpendicular to the boundary (that is, equal to the normal), there is no change in the direction of the light as it enters the second medium.

When scanning an interface between two media, since the electromagnetic wave such as laser, or even light will have to traverse two media, refraction will occur and thus cause a distortion of the scan/image result. Further, there are likely further distortions caused by another characteristic of liquid medium, which is waves, and such waves only escalate challenge of imaging at an air-water interface or such media, because the waves cause refraction of light in many different directions. From ripples on a pond to deep ocean swells, sound waves, and light, all waves share some basic characteristics. Broadly speaking, a wave is a disturbance that propagates through space. Most waves move through a supporting medium, with the disturbance being a physical displacement of the medium. The time dependence of the displacement at any single point in space is often an oscillation about some equilibrium position. For example, a sound wave travels through the medium of air, and the disturbance is a small collective displacement of air molecules individual molecules oscillate back and forth as the wave passes.

Unlike particles, which have well-defined positions and trajectories, waves are not localized in space. Rather, waves fill regions of space, and their evolution in time are not described by simple trajectories. This is essentially problematic since the distortion of imaging through an interface characterized by such waves would be defined by complex geometry rather than simple mathematical relationships. It is also important to consider one defining characteristic of all waves, which is superposition, which describes the behaviour of overlapping waves. The superposition principle states that when two or more waves overlap in space, the resultant disturbance is equal to the algebraic sum of the individual disturbances. It is thus important for any solution to factor in for these possibilities in order to provide a workable design for through-water scanning.

On the other hand, machines can be taught to interpret images the same way human brains do and to analyze those images much more thoroughly than we can. For example, when applied to image processing, artificial intelligence (AI) can power face recognition and authentication functionality for ensuring security in public places, detecting and recognizing objects and patterns in images and videos, image correction applications, and so on.

Image enhancement is the process of improving the picture quality without any information loss so that the results are more suitable for display (desired resolution, color, and style), or prepare images for further analysis in various computer vision applications, including object detection, image classification, scene understanding, and much more. Image enhancement usually consists of several transformations like image denoising, deblurring, up-scaling, contrast enhancement, lighting up low-light pictures, removing optical distortion, etc. Image post-processing has always been an essential part of the whole photography process, and it is required to address common photographic flaws, and is done by image enhancement algorithms.

Deep learning (DL), on the other hand, is a relatively new field of machine learning (ML), and it can be effectively applied to image processing. Different types of neural networks can be utilized for solving different image enhancement tasks, for example, successful denoising, producing high-resolution images from low-resolution images by training super-resolution, and much more.

As with all inventions that are based off the necessity to improve prior art, the current invention has identified a gap in the prior art, in that there is not a reliable system and method for accurate scanning/imaging an object profile in an air-water interface (AWI).

This disclosure presents an apparatus, system and methods for image distortion correction for accurate scanning/imaging an object profile in an air-water interface (AWI).

### SUMMARY OF THE INVENTION

The following summary is an explanation of some of the general inventive steps for the system, method, architecture and tools in the description. This summary is not an extensive overview of the invention and does not intend to limit the scope beyond what is described and claimed as a summary.

The present invention, in some embodiments thereof, relates to apparatus, system and methods for image distortion correction when scanning/imaging an air-water interface (AWI), or any such interfaces between two media including air and glass, among others. According to one embodiment, the apparatus comprises of a means of scanning a mean water level, and two scanners, wherein is set slightly above the water surface, and one positioned just below, with the scanners having an intersecting view of the AWI. A suitably trained machine learning algorithm recognizes key features from both the above-water and underwater scans, determines distortion from the AWI, make a correction of the distortion and automatically stitch the distortion-corrected scans together. According to another embodiment, the resulting single complete, accurate, and high-density point cloud of all surface profiles in, around, and below the AWI area.

### BRIEF DESCRIPTION OF THE FIGURES

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 of the drawings illustrates an arrangement of the primary apparatus adapted for through-water imaging

FIGS. 2a and 2b of the drawings is an illustration of a height adjustable platform to support two imaging apparatus, one above and one below an air-water interface.

FIG. 3 of the drawings illustrates an arrangement of apparatus adapted for through-water imaging that includes secondary imaging apparatus in the water and in the air

FIGS. 4a, 4b and 4c of the drawings illustrate the refraction, reflection and dispersion of light at an air-water interface that would cause distortion of an image.

FIGS. 5a and 5b of the drawings is an illustration of a process diagram for the training of a machine learning engine, and the use of a trained machine learning engine to make an inference.

FIG. 6 of the drawings is an illustration of a block diagram for the training of a neural network to perform an image distortion correction for through water imaging.

FIG. 7 of the drawings is an illustration of a process diagram for the training of a neural network to perform an image distortion correction for through water imaging.

FIG. 8 of the drawings is an illustration of a process diagram for the use of a trained machine learning model for through water image distortion correction.

### DETAILED DESCRIPTION OF THE INVENTION

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the terms imaging apparatus and scanner may be used interchangeably, and will generally be directed at any such equipment capable of using electromagnetic, sonar or optical means to obtain the surface profile of an object.

Further in this disclosure, the terms scans, images or point clouds may be used interchangeably and will generally be directed at any such obtained surface profiles of an object by means of an imaging apparatus or scanner.

Still, the term AWI will be used to mean an air-water interface, however this is representative of all types of interfaces between media of different refraction index.

The term MWL may be used in this disclosure to mean the mean water level at an interface between air and water, however this is representative of all types of interfaces between media of different refraction index.

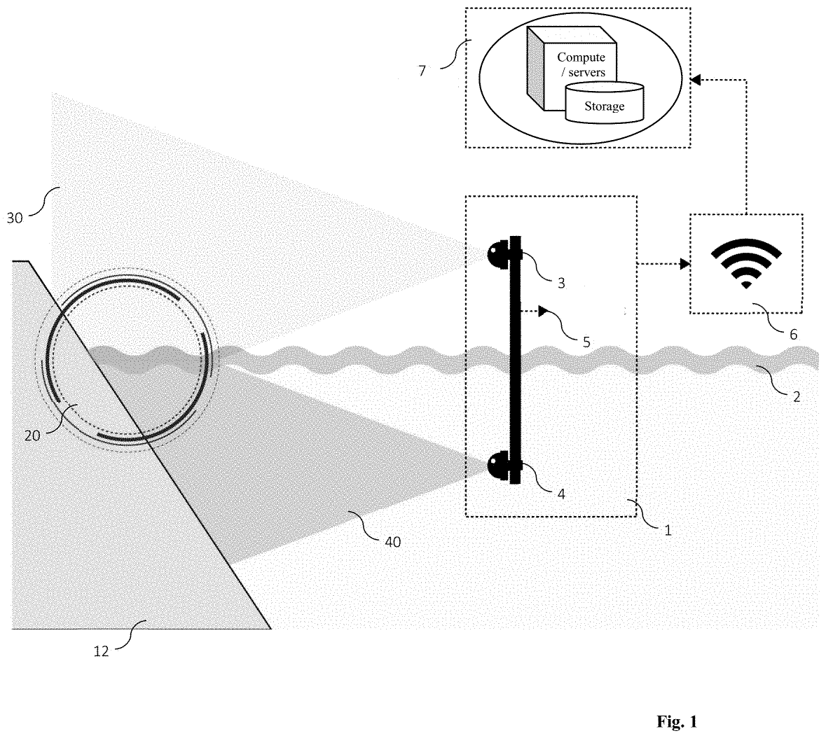

In the first embodiment according to FIG. 1 of the diagrams, it is illustrated an arrangement of the primary apparatus adapted for through-water imaging. A platform 1 is provided, intersecting an air-water interface (AWI) or any such interface between two media to support an imaging apparatus 3 above the AWI and an imaging apparatus 4 below the AWI. The platform 1 has a means 5 of adapting the length, and thus the separation between the imaging apparatus 3 above the AWI and the imaging apparatus 4 below the AWI. Typically, imaging the artifact 12 in the zone 20 located at the air-water interface is problematic due to refraction of light that causes distortion of any images, and further because a medium such as water typically has wave formations that cause refraction in different angles resulting in distorting interference patterns, exacerbating the problem even further and causing any images taken to be completely unusable. The platform 1 disclosed herein is coupled to a transmission means 6, which is any such medium for transmitting data or files between the platform and the compute resource 7. The transmission means may be a wired connection such as cables, Ethernet, LAN cables among others, or any such wireless means such as Wi-Fi, Z-wave, Zigbee, Bluetooth, the internet among others. As such, in some embodiments, the transmission means may performed via a cabled network, and in other embodiments, wirelessly. According to the current disclosure, the compute resource 7 may include any such means that comprise at least one processor unit, a storage device and programmable memory such as a server, computer, a cloud compute instance, a smartphone or any such means capable of performing a computational task.

Further, and according to the same FIG. 1, the platform 1 provides a means to support the imaging apparatus 3 above the AWI and the imaging apparatus 4 below the AWI, preferably the platform being positively buoyant such that the imaging apparatus 3 is always above the AWI. The imaging apparatus 3 has a filed of view 30 in that the field of view intersects the AWI from above at the zone 20 of the artifact 12 located at the air-water interface, whereby the apparatus is capable of imaging or scanning the artifact in the zone 20. On the other hand, the imaging apparatus 4 is always below the AWI. Similarly, the imaging apparatus 4 has a filed of view 40 in that the field of view intersects the AWI from below at the zone 20 of the artifact 12 located at the air-water interface, whereby the apparatus is capable of imaging or scanning the artifact in the zone 20.

According to one embodiment, the arrangement works like so, the imaging apparatus 3 and 4 will take a plurality of images, both above and below the interface and transmit them to the compute resource 7 via the transmission means 6. The compute resource 7 comprises a suitable computer program product on its memory adapted to determine the location of the interface at any point in time for images taken at the same time from above and below. The computer program then stitches together the images into a single surface profile image/data point cloud/etc. based on the surface profile for interface location. It is anticipated that the imaging apparatus is comprised of photography equipment, sonar equipment, optical, ultrasound equipment, radiography equipment, or any such equipment capable of imaging or scanning a surface using electromagnetic means.

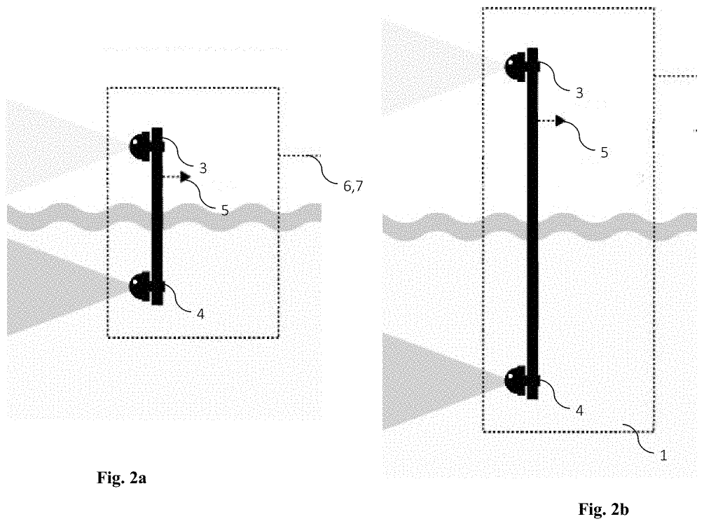

In an embodiment exemplified by the accompanying FIGS. 2a and 2b of the diagrams is an illustration of a height adjustable platform to support two imaging apparatus, one above and one below an air-water interface. The platform is preferably positively buoyant such that it can maintain the imaging apparatus 3 above the air-water interface, with its mid section at about the air-water interface, and thus the imaging apparatus 4 below the air-water interface. In the FIG. 2a, the platform adjustment means 5 has been activated to reduce the length between the imaging apparatus 3 and 4. On the other hand, and in the FIG. 2b, the platform adjustment means 5 has been activated to increase the length between the imaging apparatus 3 and 4. As was illustrated in FIG. 1, the platform is coupled to a transmission means 6 and compute resource 7.

The primary scanning units 3 and 4 are of the current invention preferable to be integrated platforms with all components housed within a single portable IP68 waterproof chassis. With a powerful wireless communication means and waterproofed internal components, the platform 1 is anticipated to be a cordless device. The components selected will have underwater applications in mind and be optimized for use in hydraulic laboratory conditions. However, it is also anticipated that a corded application would also work well in solving the problem.

It is anticipated that the applicable range of height adjustable mechanisms encompasses three lift systems: electric, manual and brackets. Generally, and in accordance with the current invention, the adjustable mechanisms, or re-configurable or programmable mechanisms, are mechanisms in which one or more of their parameters are made adjustable. The height adjustment of the platform allows the changing of the field of view of the imaging apparatus, or focus on a different position of the artifact at the air-water interface. It is further anticipated that the types of adjustment mechanisms may include linear, tilt and rotary adjustments among others.

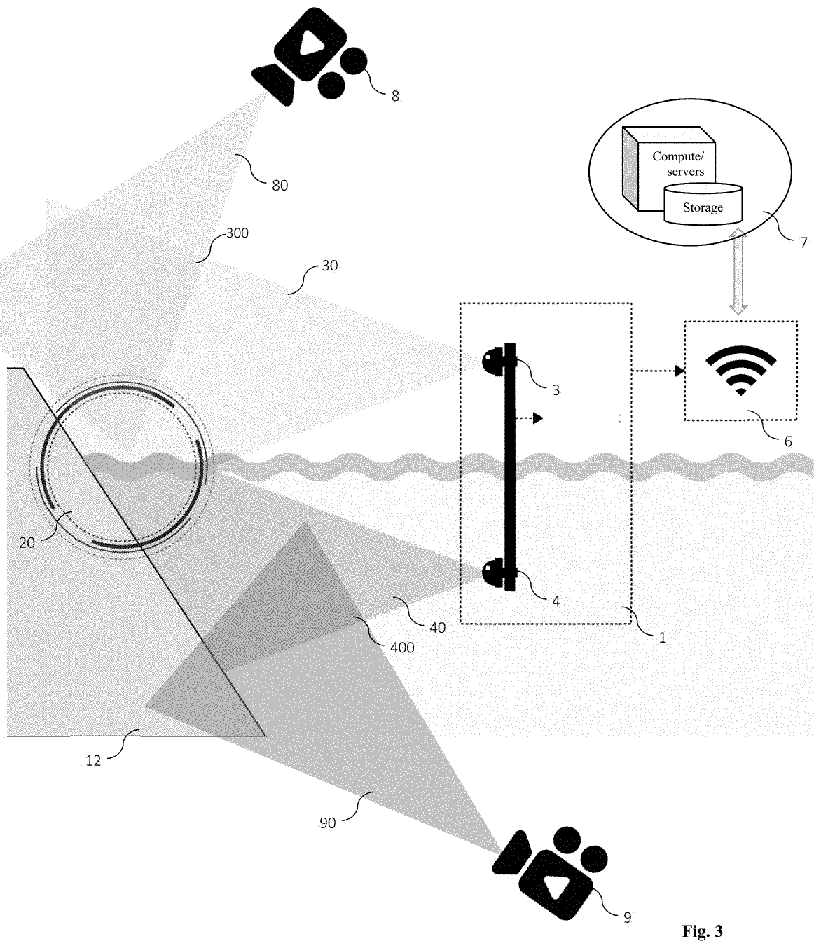

In the embodiment according to the FIG. 3 of the drawings it is illustrated an arrangement of apparatus adapted for through-water imaging that includes secondary imaging apparatus in the water and in the air. It is to be noted that while the apparatus has been adapted to work in the air-water interface, the apparatus can also work for any other non-uniform media such as air and oil, oil and water, among others, to scan the zone of an artifact located in the media boundary. According to the figure, the imaging apparatus 3 has a filed of view 30 in that the field of view intersects the AWI from above at the zone 20 of the artifact 12 located at the air-water interface, whereby the apparatus is capable of imaging or scanning the artifact in the zone 20. Further, a secondary scanner 8, with a field of view 80, is located above the first scanner 3 in the first medium (air), wherein the two fields of view intersect at 300. The objective of the intersection is to make it possible to stitch a continuous image from the air-water interface at 20, and across the artifact to get a more complete view of the artifact.

On the other hand, the imaging apparatus 4 is always below the AWI, where a complimentary secondary scanner 9 with a field of view 90 is provided. In a similar fashion, the imaging apparatus 4 has a field of view 40 in that the field of view intersects the AWI from below at the zone 20 of the artifact 12 located at the air-water interface, whereby the apparatus is capable of imaging or scanning the artifact in the zone 20. For the secondary scanner 9, the field of view 90 in the second medium (water) intersects with the field of view 40 of the second primary scanner 4, wherein the two fields of view intersect at 400. Again, the objective of the intersection is to make it possible to stitch a continuous image from the air-water interface at 20, and across the artifact to get a more complete view of the artifact 12 in the second medium.

In a preferred embodiment, it is expected that the platform 1 able to support scanning from as far as 2.0 meters of distance from the artifact 12, thus ensuring that the scans can be non-intrusive no matter the operational environment. The platform and imaging/scanning apparatus should be light enough to be portable (preferably about 10 kg such that when suspended in water, a person will be able to hold for an extended period. However, even heavier or lighter equipment would still work as well) giving the option of being either human operated or drone/ROV-mounted, depending on individual use cases. For the primary imaging apparatus, so long as scanning is continuous, it would be possible to detach or rotate individual scanners flexibly in-situ. The two or more secondary scanner units 8 and 9 may be deployed for scanning alternative fields of view, increasing the field coverage, uniformity, and scan speed, as well as flexible scanning around complex objects, thus removing any shadow zones. It is anticipated that the additional scanning units may be built around a single portable scanner which will be either human-operated or drone/ROV-mounted, depending on the particular needs of each use case. The scan time required to achieve the required outcomes, ignoring post-processing, is expected to be well within the guidelines set, but reduced scan speeds will improve the uniformity of the scan.

For both secondary scanners 8 and 9, the objective of the secondary imaging is to stitch the images/scans of portions secondary to the zone 20 of the artifact since the primary scanners may probably not fully cover the entire artifact 12. It is to be understood further that in the arrangement demonstrated by the FIG. 3 of the drawings, the imaging apparatus 3 and 4 will take a plurality of images, both above and below the interface, while the secondary scanners 8 and 9, will scan the zones secondary to the imaging apparatus 3 and 4 respectively and transmit both the primary and secondary images to the compute resource 7 via the transmission means 6. It is anticipated that the primary and secondary imaging/scanning apparatus may be based on optical, sonar or laser equipment. The compute resource 7 comprises a suitable computer program product on its memory adapted to determine the location of the interface at any point in time for images taken at the same time from above and below. The computer program then stitches together the images from above the interface, below the interface, and the secondary imaging into a single surface profile image/data point cloud/etc. based on the surface profile for interface location and the secondary location of the artifact.

The scan resolution of any scanner may be selected during the calibration phase. In the case of drone/ROV-mounted operation, the scanning speed and routes may be selected prior to deployment and be modified as required. Wireless transmitters will send initial point cloud scans to an operator using the compute resource 7 in real-time, and in the case of human-operation, both a miniature real-time display and a warning indicator may be mounted on the scanning unit which will inform the operator if the program believes the area requires additional scanning. This real-time processing and post-processing computer program may be developed for any operating system.

One possible problem of the arrangement is the occurrence of an object blocking the intersecting fields of view of the primary scanner unit, occurring primarily at very shallow depths in the AWI area, due to the interference of the water surface limiting the possible fields of view. A possible solution to this problem is for the above-water scanner 3 of the primary scanning unit to be able to scan through the water surface to a limited depth. In conjunction with a high-resolution optical scanner, the unit should determine the exact water surface fluctuations, allowing a suitable computer program to reconstruct through-water surface profiles to a limited depth with great accuracy.

Using a suitably trained machine learning algorithm, the suitable computer program is able to identify the high and low points in the water surface heights. By preferably utilizing a neural network such as a Deep Neural Network (DNN), the program will be trained to recognize key features from both the above-water and underwater scans, allowing optimal measurements based on surface properties and automatically stitch together the scans in post-processing. The high-power primary scanners will produce high-resolution scans of the surface profiles of solid objects, porous objects, and topography in and surrounding the AWI area. The result will be a single complete, accurate, and high-density point cloud of all surface profiles in, around, and below the AWI area.

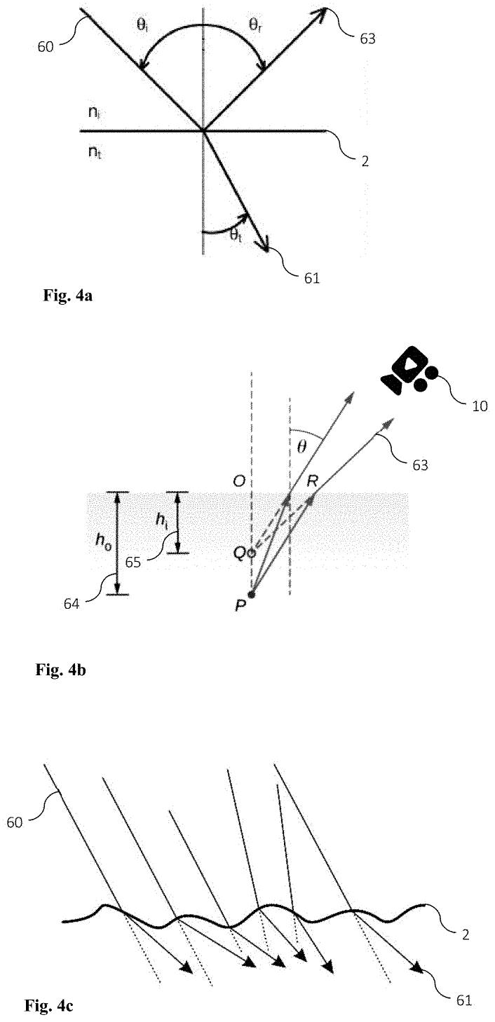

In the embodiment according to FIGS. 4a, 4b and 4c of the drawings, it is illustrated the refraction, reflection and dispersion of light at an air-water interface that would cause distortion of an image. In the first FIG. 4a, the diagram illustrates the general behaviour of light as it traverses media if differing refractive indices. Specifically, the figure illustrates what happens when electromagnetic radiation crosses a smooth interface into a dielectric medium that has a higher refractive index (nₜ>n₁). We see two phenomena: reflection and refraction (a specific type of transmission). The angle of reflection, Or, equals the angle of incidence, θᵢ, where each is defined with respect to the surface normal. The angle of refraction, θₜ, (t for transmitted) is described by Snell's law (of Refraction): nᵢ sin θᵢ=nₜ sin θₜ.

During an imaging operation, when light traveling in one transparent medium encounters a boundary with a second transparent medium (e.g., air and glass), a portion of the light is reflected and a portion is transmitted into the second medium. As the transmitted light moves into the second medium, it changes its direction of travel; that is, it is refracted. The law of refraction, Snell's law above, describes the relationship between the angle of incidence (θᵢ) and the angle of refraction (θₜ), measured with respect to the normal (“perpendicular line”) to the surface, in mathematical terms: n₁ sin θᵢ=nₜ sin θₜ, where nᵢ and nₜ are the index of refraction of the first and second media, respectively. The index of refraction for any medium is a dimensionless constant equal to the ratio of the speed of light in a vacuum to its speed in that medium. A ray of light 60 in the first medium with an incidence angle θᵢ is transmitted in the second medium as 61, with an angle of refraction θₜ.

In the second FIG. 4b, the diagram illustrates an imaging apparatus 10 in a first medium 1, scanning an object P in a second medium and a height 64 from the medium 1-medium 2 interface. Due to rarefaction as light traverses the two media, the object P will appear as Q at a height 65 from the interface. The apparatus 10 will view the refracted ray 63, which is distorted and does not represent the true details of the object P.

In the FIG. 4c, the diagram illustrates an interface between two media, for example, air and water, or any other liquid, the liquid exhibiting wave formation patterns on the surface at the interface 2. Due to the wave formation at the surface, the light rays will hit the interface at different angles, causing them to be refracted in may different directions. For example, a ray 60 hits the interface different from all other rays thus being refracted at different angle such as the refracted ray 61, which has a different refraction angle as the ray 60.

In the current technical application of scanning/imaging an artifact through an interface of two media such as air and water, since the electromagnetic wave such as laser, or even light will have to traverse two media, refraction will occur and thus cause a distortion of the scan/image result. This is also likely to cause distortion of sonar waves. Further, there are likely more distortions caused by waves in the liquid medium, and such waves only escalate challenge of imaging at an air-water interface or such media, because the waves cause refraction of light in many different directions.

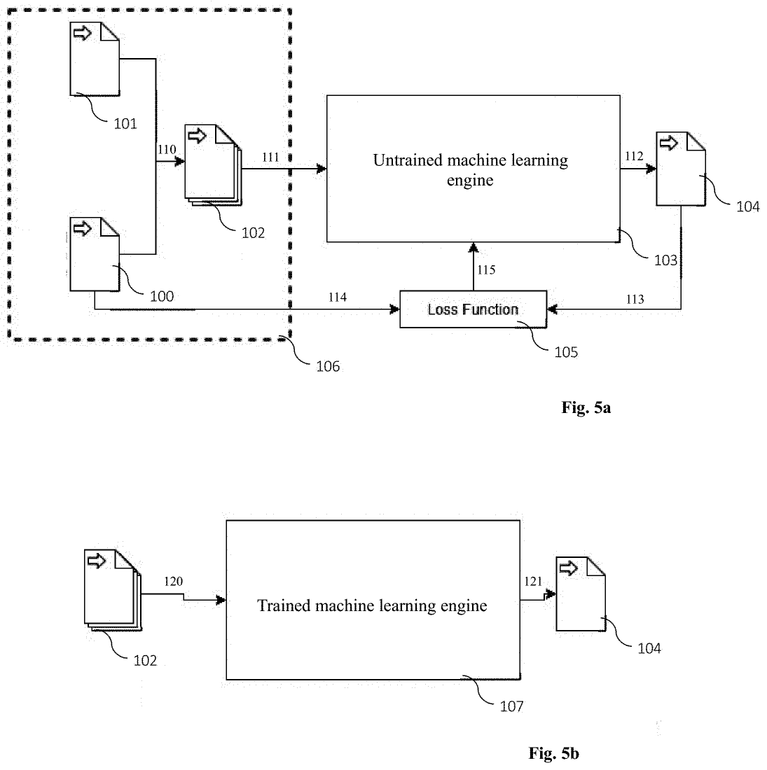

The subsequent embodiment as in FIGS. 5a and 5b of the drawings is an illustration of a process diagram for the training of a machine learning engine to perform image distortion correction, and the use of the trained machine learning engine to make an inference of a clear non-distorted image. In the FIG. 5a, illustrating the training of a machine learning engine to perform image distortion correction, it is shown ground truth (labeled data) data 100, a fluid dust model 101 capable of determining a pattern associated with ground truth data (labeled data without noise) and distorted image data 102, which are formed in the image generator 106. The distorted image data 102, labeled data 100 and a fluid dust model 101 are provided to the untrained machine learning engine 103 in a process 111. It is noteworthy that a labeled data 100 comprises an image or scan of a section taken outside the refractive interference and thus has no distortion. The measured interference data 101, on the other hand is provided upon a determination of the surface interference patterns as at the time of taking the distorted images 102, and is in the form of a disturbance model. The fluid dust model 101, and labeled data 100 are provided in the process 110 to be used in training the untrained machine learning engine 103. A generator in the untrained machine learning engine 103 attempts to predict a noiseless image from the received distorted image data 102 in a process 112, the result being the predicted image 104. Preferably, the generator will use the interference data and distorted image data to attempt to make a prediction. A discriminator 105 is then utilized to determine the loss function, wherein the predicted image is provided in the process 113 for comparison with ground truth data 100 provided in 114. The loss function is passed back to the untrained machine learning engine 103 as in 115 to improve the prediction model until the model is capable of predicting an image 104 that can be deemed equivalent to the ground data 100 by the discriminator (i.e. can fool the discriminator as a ground truth) with the required accuracy. While the current disclosure favors the use of a Convolution Neural Network for the machine learning algorithm, it is anticipated that any algorithm with an acceptable accuracy is also anticipated, and this may include other neural networks, classifiers, computer vision algorithms, Deep Neural Networks, Feature Space Augmentation & Auto-encoders, Generative Adversarial Networks (GANs), and Meta-Learning.

For the avoidance of doubt, the training of a machine learning algorithm will require a plurality of distorted images 102, labeled data 100, since that is the only way to generate a useful prediction model capable of distortion correction. Also, for each of the plurality of distorted images 102, an interference pattern that includes waves may also contribute to the distortion or noise, and as such an interference or surface disturbance scan may also be performed by the imaging apparatus at the air-water interface (or any such interface between two media), wherein such a profile may provide useful patterns. The output of a training process is a trained machine learning engine capable of noise/distortion correction from distorted images.

A suitable computer program provided in the compute resource 7 of FIGS. 1, 2 and 3, in addition to stitching together these point clouds (or images), is preferably be trained to recognize problem areas inherit with scanning complex systems. These areas may be highlighted, and by utilizing a machine learning engine trained to extrapolate what the data should look like. These optional point clouds may be used to supplement the stitched point cloud data-sets, albeit rendered in a different data-set and color. It is anticipated that the resulting point cloud data-sets (or images) (both raw and post-processed) are expected to have the same output file standards as used by other third-party software.

In the FIG. 5b, illustrating the use of the trained machine learning engine to make an inference of a clear non-distorted image, it is shown a distorted image 102, comprising of an image taken from above the media interface and one from below the interface as in FIG. 1 or FIG. 3 above, wherein the imaging apparatus 3 and 4, will take the images while simultaneously recording surface patterns. Once received a suitable computer program will target the surface pattern data and map our the interference. It would also determine the location of the interface at any point in time for images taken at the same time, and then stitch together the images into a single surface profile image/data point cloud/etc. based on the surface profile vs interface location. It is anticipated that the image may be any such representation including data point cloud or images. Upon receipt of the image as in 120, the trained machine learning engine 107 is adapted to determinate the distortion of the received image to predict an image 104 that dies not have the distorting noise caused by the interface.

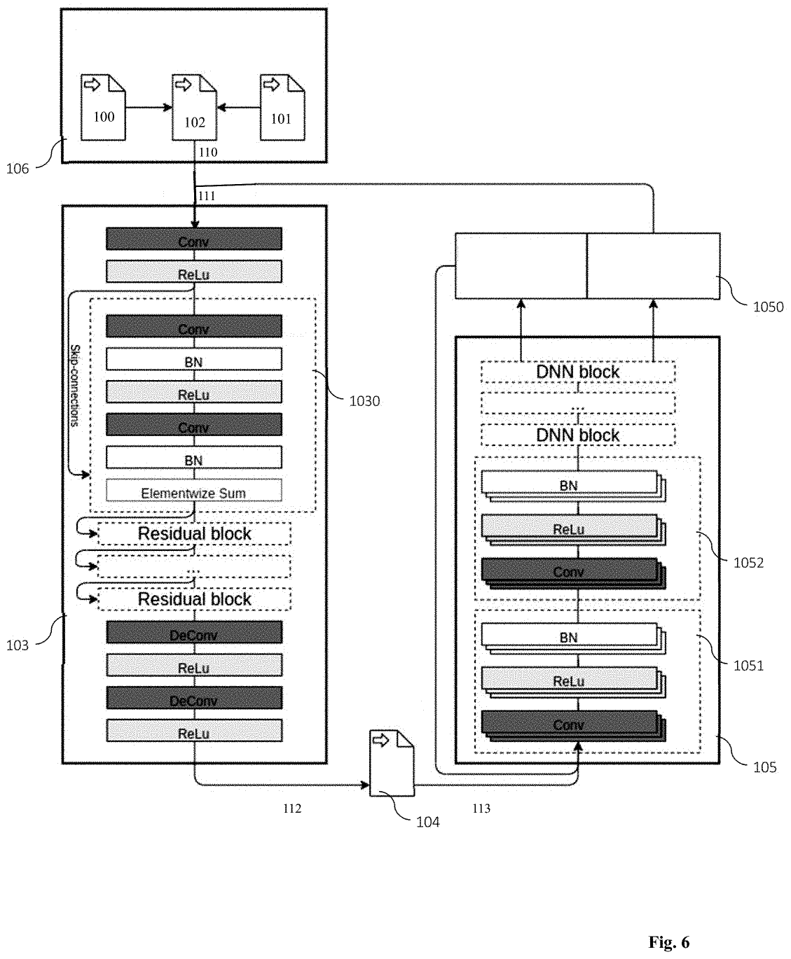

In the proceeding embodiment according to the FIG. 6 of the drawings is an illustration of a block diagram for the training of a neural network to perform an image distortion correction for through water imaging. The embodiment is that of a convolution neural network. An image generator 106 is shown, wherein ground data (labeled data) 100, a fluid dust model 101 capable of determining a pattern associated with ground truth data (labeled data without noise), and the distorted image data 102 are provided in a step 110 to an untrained machine learning engine 103. The engine comprises of a plurality of residual blocks such as 1030. In the context of the current invention, a residual block is when the activation of a layer is fast-forwarded to a deeper layer in the neural network. It could also be a stack of layers set in such a way that the output of a layer is taken and added to another layer deeper in the block. The non-linearity is then applied after adding it together with the output of the corresponding layer in the main path. An image is taken through all these blocks until a prediction 104 is made by the final block in the engine.

On the other hand, a residual block shall be comprised of a Rectified Linear Unit (ReLU), which is a non-linear activation function that performs on multi-layer neural networks. The Rectified Linear Unit, or ReLU, is not a separate component of the convolutional neural networks' process. It's a supplementary step to the convolution operation. Further contained therein is a Convolutional Neural Network (Cony/CNN), which is a Deep Learning algorithm which can take in an input image, assign importance (learnable weights and biases) to various aspects/objects in the image and be able to differentiate one from the other. Also important is the Batch normalization (BN), which is a layer that allows every layer of the network to do learning more independently. It is used to normalize the output of the previous layers. The activations scale the input layer in normalization.

The prediction 104 is then passed on to a discriminator 105, comprised of a plurality of deep neural network blocks (DNN) such as 1051 and 1052, which attempt to distinguish predicted images from the ground truth. More precisely, once an image 104 is predicted as in 112, it is passed to the discriminator as in 113, to determine a loss function 1050, which could be caused by either a generator or discriminator. The loss function may then be passed back to the generator to retrain the engine until an appropriate accuracy is achieved. In the context of the current invention, a generator is a function that behaves like an iterator. An iterator loops (iterates) through elements of an object, like items in a list or keys in a dictionary. On the other hand, a discriminator in a neural network is simply a classifier. It tries to distinguish real data from the data created by the generator. It could use any network architecture appropriate to the type of data it's classifying.

The current invention uses the machine learning engine to understand the variances in water surface height (ripples, currents) in order to get around the interference caused by the properties of the water surface for scans in the AWI area. It is anticipated that interference problem would give an expected water surface height variance of over 1.0-2.0 cm, while the solution of the invention would have a measurement error preferably within 1.0 mm or less with the correction factors from the trained prediction water surface model, which is preferably generated by processing the data from an RGB camera through our 3D water surface ripple model. The difference in scale between the water surface height variance and a measurement resolution should allow for more than enough data from the AWI area to be recorded by both scanners. Additionally, since the platform 1 of FIG. 1 is anticipated as a modular platform, it should handle larger variances in MWL, increasing the use cases of our solution.

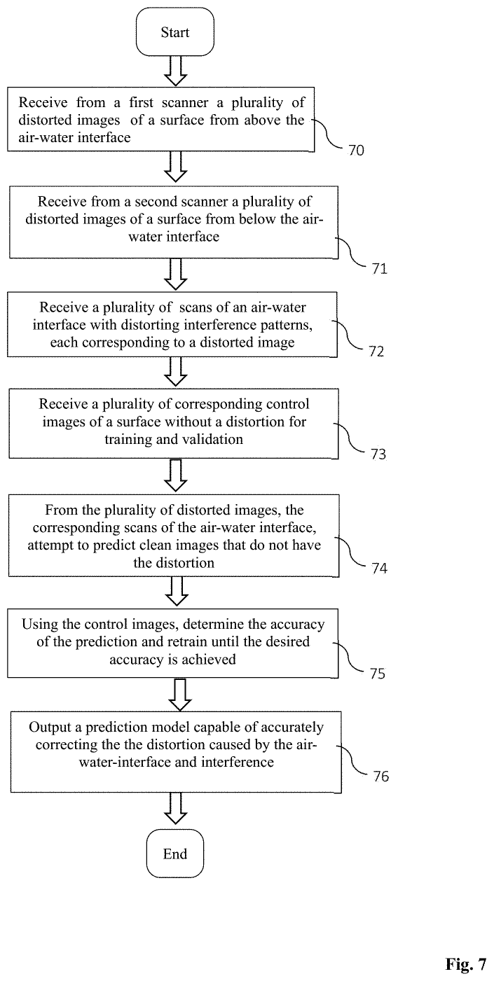

In the embodiment according to FIG. 7 of the drawings is an illustration of a process diagram for the training of a neural network to perform an image distortion correction for through water imaging. The first step 70 entails the receiving from a first scanner a plurality of distorted images of a surface from above the air-water interface. The next step 71 is the receiving from a second scanner a plurality of distorted images of a surface from below the air-water interface. In some implementation, the imaging from the first and second scanners may be stitched into a continuous image with a distortion caused by the interference. The stitching may also comprise the use of secondary scanners that would be able to provide a much broader view of an artifact under inspection.

Next, in the step 72 is the receiving of a plurality distorting interference patterns, each corresponding to a distorted image received from above or below the air-water interface, and wherein the interference may be a measured value or determined by a suitable computer program in the compute resource 7. Further, in the step 73 is the receiving of a plurality of corresponding control images of a surface without a distortion for training and validation, the control images constituting the ground truth and made up of labeled data. Next in 74 is to attempt to predict clean images that do not have the distortion from the plurality of distorted images, the corresponding scans of the air-water interface. Next is the using of the control images to determine the accuracy of the prediction and retrain until the desired accuracy is achieved in a step 75. The final step 76 of the training is to output a prediction model capable of accurately correcting the distortion caused by the air-water-interface and interference.

It is anticipated that the trained algorithm could be any such machine learning algorithm capable of distortion correction including neural networks, support vector machines, among others, and for purposes of this disclosure, it may be referred to simply as machine learning algorithm.

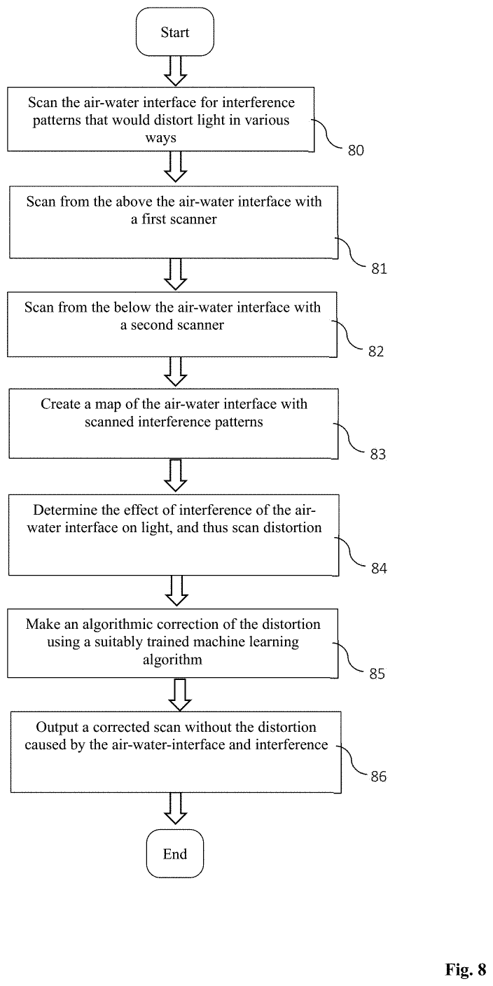

In the exemplary embodiment according to FIG. 8 of the drawings is an illustration of a process diagram for the use of a trained machine learning model for through water image distortion correction. Starting with a trained prediction model capable of accurately correcting the distortion caused by the air-water-interface and interference generated as in the FIG. 7 above, the first step 80 is to scan the air-water interface for interference patterns that would distort light in various ways, and this may be done by the primary scanners at the air-water interface or extracted by a suitable computer program. The next step 81 is to scan from the above the air-water interface with a first scanner to obtain a view from above the interface. Next in 82 is to scan from the below the air-water interface with a second scanner to obtain a view from below the interface. Next in 83 is to create a map of the air-water interface with scanned interference patterns, wherein the two images would intersect at the interface. This step is preferably performed by a suitable computer program capable of distinctively determining the features in both images from above and below and stitching them together into a single feature map.

Subsequently in the step 84 is the determination of the effect of interference of the air-water interface on light, and thus scan distortion on the stitched image in readiness for the distortion correction. Next in 85 is to make an algorithmic correction of the distortion using a suitably trained machine learning algorithm, whereby the distorted image is passed through the trained prediction model, which used a suitable algorithm to predict a clear image. Finally in the step 86 is to output a corrected scan without the distortion caused by the air-water-interface and interference. In further processing, a predicted image without distortions caused by refraction and interference at an air water interface may be coupled to secondary scanners. The secondary scanners can take additional images of the zone and these images can be stitched to the predicted.

It is anticipated that the imaging apparatus may comprise of a means to stitch images taken by the primary scanners.

It is also anticipated that the primary imaging apparatus may comprise a means to measure the dimensions of an artifact zone under imaging.

It is anticipated that the secondary imaging apparatus may comprise a means to measure the dimensions of an artifact zone under imaging.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICATION

The invention is applicable in the imaging industry, and specifically in the improving imaging through different media such as across air and water, among others.

1. A system for image distortion correction at an interface between two media of different refractive indices, the system comprising of:
a scanning unit comprising of:
a first scanner in a first medium just above the two media interface, wherein said first scanner is capable of imaging an artifact at the two media interface from above the two media interface;
a second scanner in a second medium just below the two media interface, wherein said second scanner is capable of imaging an artifact at the two media interface from below the two media interface;
a support means for said first and second scanners, said support means defining a separation between said first and second scanners, said support means traversing the two media and maintaining said scanners just above and just below the two media interface, and;
a transmission means capable of transmitting the scanner outputs to a computing resource for distortion correction; and
a computing resource comprising of a suitably trained machine learning algorithm, the computing resource being adapted to:
receive image transmission of an artifact from at least one of the first and second scanners of the scanning unit of just above and just below the two media interface;
recognize key features from at least one the above and below the two media interface scans;
determine distortion caused by the two media interface;
make a correction of the distortion, and;
output a clear image of an artifact or a portion of it at the two media interface.

2. The system as in claim 1, wherein the images received by the computing resource comprise of point clouds.

3. The system as in claim 1, wherein the scanners of the scanning unit comprise one or more of any such type of sensors including but not limited to optical, sonar, laser sensors.

4. The system as in claim 1, wherein the scanning unit floats in the second medium about its mid section such that a first scanner is maintained in the first medium just above the two media interface, and a second scanner is maintained in the second medium just below the two media interface.

5. The system as in claim 4, wherein said media are gas and liquid

6. The system as in claim 4, wherein said media are liquids of different refractive indices

7. The system as in claim 1, wherein the support means is adaptable to vary the defined separation between said first and second scanners.

8. The system as in claim 1, further comprising at least one secondary scanner deployed for at least one or more of:
scanning alternative fields of view;
increasing the field coverage;
improving the uniformity of a scan;
improving the scan speed; and
improving the flexibility of scanning around complex objects to remove any shadow zones.

9. The system as in claim 8, wherein the secondary scanners are adapted measure the dimensions of the artifact or zone under scanning.

10. The system as in claim 1, wherein the computing resource is capable of stitching additional images of an artifact taken from secondary scanners into the predicted clear image of the artifact or a portion of it at the two media interface.

11. A method of training a machine learning algorithm for image distortion correction at an interface between two media of different refractive indices, the method comprising of:
receiving from a first scanner a plurality of distorted images of a surface profile of an artifact from above a two media interface;
receiving from a second scanner a plurality of distorted images of a surface profile from below the two media interface;
receiving of a plurality distorting interference patterns, each corresponding to a distorted image received from above or below the two media interface, wherein the interference may be a measured value or determined by a suitable computer program;
receiving a plurality of corresponding control images of the scanned surface profile without a distortion, the control images constituting the ground truth and made up of labeled data;
attempting to predict clean images that do not have the distortion from the plurality of distorted images;
using of the control images to determine the accuracy of the prediction and retrain until the desired accuracy is achieved, and;
outputting a prediction model capable of accurately correcting the distortion caused by the two media interface and interference

12. The method of claim 11, further comprising the stitching the corresponding images from the first and scanners into a continuous image with a distortion caused by the interference prior to attempting to predict clean images that do not have the distortion from the plurality of distorted images.

13. The method of claim 11, wherein the machine learning algorithm comprises any such machine learning algorithm capable of distortion correction including but not limited to neural networks, support vector machines, or any such.

14. A method of using a trained machine learning algorithm for image distortion correction at an interface between two media of different refractive indices, the method comprising of:
receiving from a first scanner a plurality of distorted images of a surface profile of an artifact from above a two media interface;
receiving from a second scanner a plurality of distorted images of a surface profile from below the two media interface;
creating a map of the two media interface with scanned interference patterns, wherein the two images would intersect at the interface;
determining of the effect of interference of the two media interface on light;
making an algorithmic correction of the distortion using a suitably trained machine learning algorithm, whereby the distorted image is passed through the trained prediction model, which used a suitable algorithm to predict a clear image, and;
outputting a corrected scan as a clear predicted image without the distortion caused by the two media interface and interference

15. The method of claim 14, wherein the creating a map of the two media interface with scanned interference patterns where the two images would intersect at the interface is performed by a suitable computer program capable of distinctively determining the features in both images from above and below and stitching them together into a single feature map.

16. The method of claim 14, further comprising the stitching the corresponding images from the first and scanners into a continuous image with a distortion caused by the interference prior to making an algorithmic correction of the distortion.

17. The method of claim 14, wherein the machine learning algorithm comprises any such machine learning algorithm capable of distortion correction including neural networks, support vector machines, or any such.

18. The method of claim 14, further comprising receiving from at least one secondary scanner deployed, at least one or more of:
a scanning of alternative fields of view;
a scanning of additional field coverage; and
a scanning around complex objects to remove any shadow zones.

19. The method of claim 14, further comprising of stitching additional images of an artifact taken from secondary scanners into the predicted clear image of the artifact or a portion of it at the two media interface.

20. The method of claim 18, wherein the trained machine learning algorithm comprises any such suitable machine learning algorithm capable of distortion correction including but not limited to neural networks, support vector machines, or any such.

21. A method for image distortion correction in through-water imaging setup, the method comprising of:
perform a scan image of an artifact from a first scanner in the air above the water interface;
perform a scan image of an artifact from a second scanners below the water media interface;
modeling of the interface surface distortion;
determine distortion and/or interference caused by the air-water interface;
make a correction of the distortion and/or interference; and
output a clear image of an artifact or a portion of it at the air-water interface.

22. The method of claim 21, further comprising the stitching the corresponding images from the first and scanners into a continuous image with a distortion caused by the interference prior to making a correction of the distortion.

23. The method of claim 21, wherein the means for image distortion correction in through-water imaging setup comprises any such computer algorithm capable of distortion correction.

24. The method of claim 21, further comprising receiving from at least one secondary scanner deployed, at least one or more of:
a scanning of alternative fields of view;
a scanning of additional field coverage; and
a scanning around complex objects to remove any shadow zones.

25. The method of claim 21, further comprising of stitching additional images of an artifact taken from secondary scanners into the predicted clear image of the artifact or a portion of it at the air-water interface.
